(19) United States
(12) Patent Application Publication
(10) Pub. No.: US 2011/0055709 A1
(43) Pub. Date: Mar. 3, 2011

(54) ELECTRONIC DEVICE AND NETWORK COMMUNICATION METHOD

(75) Inventors: CHIA-PENG WANG, Tu-Cheng (TW); LIANG-MAO HUNG, Tu-Cheng (TW); TENG-YU TSAI, Tu-Cheng (TW); JYH-GWO JU, Tu-Cheng (TW)

(73) Assignee: HON HAI PRECISION INDUSTRY CO., LTD., Tu-Cheng (TW)

(21) Appl. No.: 12/624,269

(22) Filed: Nov. 23, 2009

(30) Foreign Application Priority Data
Aug. 31, 2009 (CN) 200910306340.6

(51) Int. Cl. G06F 3/01

(52) U.S. Cl. 715/736

(57) ABSTRACT

An electronic device includes a display, a graphical user interface (GUI) application module, a daemon application module, and a network service control module capable of retrieving network content from a network terminal. The GUI application module acquires the network content from the network service control module. Either of the GUI application module or the daemon application module manages the network content.

### BACKGROUND

1. Technical Field

The present disclosure relates to electronic devices and methods, and particularly to an electronic device and a method of communication for an electronic device and a network terminal.

2. Description of Related Art

Embedded devices, for example, digital photo frames (DPFs), are becoming increasingly popular due to their convenience and ease of function. However, the typical digital photo frame can only display photos. A DPF providing Internet access is thus desirable.

### BRIEF DESCRIPTION OF THE DRAWINGS

Many aspects of the embodiments can be better understood with references to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is a block diagram of an electronic device communicating with a network terminal, in accordance with an embodiment.

FIG. 2 is a flowchart of a method, in accordance with an embodiment, of an electronic device for communicating with a network terminal to retrieve a station list.

FIGS. 3a and 3b is a flowchart of a method, in accordance with an embodiment, of an electronic device for communicating with a network terminal to retrieve a playlist.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word “module,” as used herein, refers to logic embodied in hardware or firmware, or to a collection of software instructions, written in a programming language, such as, for example, Java, C, or assembly. One or more software instructions in the modules may be embedded in firmware, such as an EPROM. It will be appreciated that modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

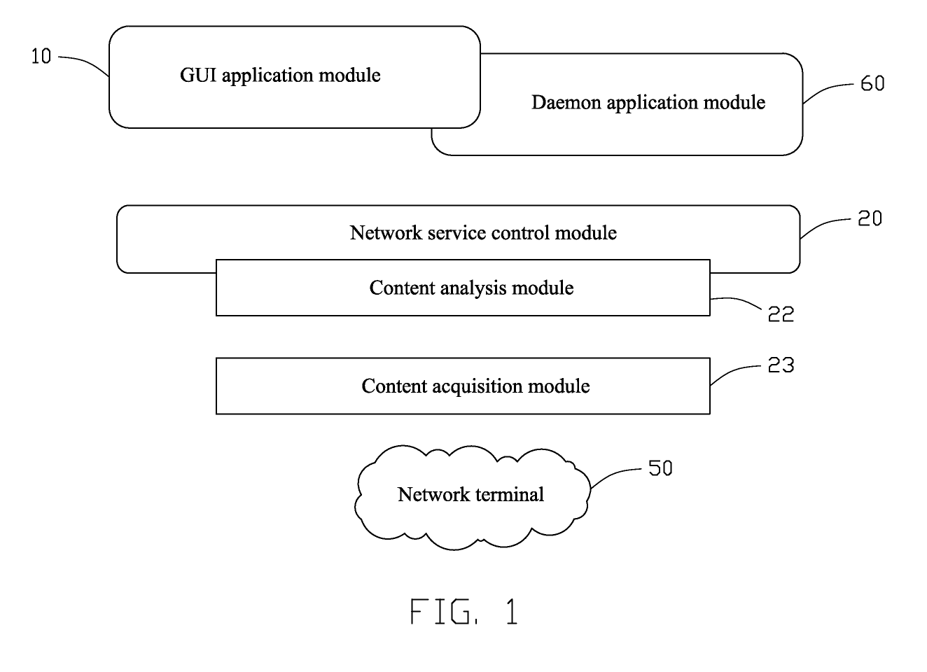

Referring to FIG. 1, an electronic device includes a graphical user interface (GUI) application module 10, a network service control module 20, a content analysis module 22, a content acquisition module 23, and a daemon application module 60. The electronic device communicates with a network terminal 50 through a network.

The GUI application module 10 retrieves network content from the network. For example, the GUI application module 10 can be a personal network radio GUI application module capable of acquiring network radio content.

The network service control module 20 acquires the network content from the network terminal 50 and routes the network content to the GUI application module 10. The network terminal 50 authorizes the network service control module 20 to retrieve the network content.

The network service control module 20 includes an application program interface (API) module 21 providing communication between the network terminal 50 and the GUI application module 10. The API module 21 retrieves the network content (such as a station list, a playlist of one station, or other) from the network terminal 50.

The content analysis module 22 connects the network service control module 20 with the content acquisition module 23. Since, when the network service control module 20 acquires the network content from the network terminal 50, both applicable and non-applicable information is retrieved, content analysis module 22 analyzes the acquired network content and extracts applicable information.

The content acquisition module 23 provides interfaces for the content analysis module 22 and the Internet service terminal 50, working asynchronously with the GUI application module 10. As the content acquisition module 23 downloads the network content from the network terminal 50, the GUI application module 10 continues to function. The content acquisition module 23 downloads the network content from the network terminal 50 via multiple threads. The content acquisition module 23 can monitor and display download progress of the network content. The content acquisition module 23 supports a hyper text transfer protocol (HTTP) header to fetch the network content. The content acquisition module 23 can download multi-service content from the network terminal 50. The network terminal 50 provides the network content to the content acquisition module 23.

The daemon application module 60 saves the network content before the GUI application module 10 is shut down. The daemon application module 60 sends the saved network content to the GUI application module 10 after the GUI application module 10 is initialized.

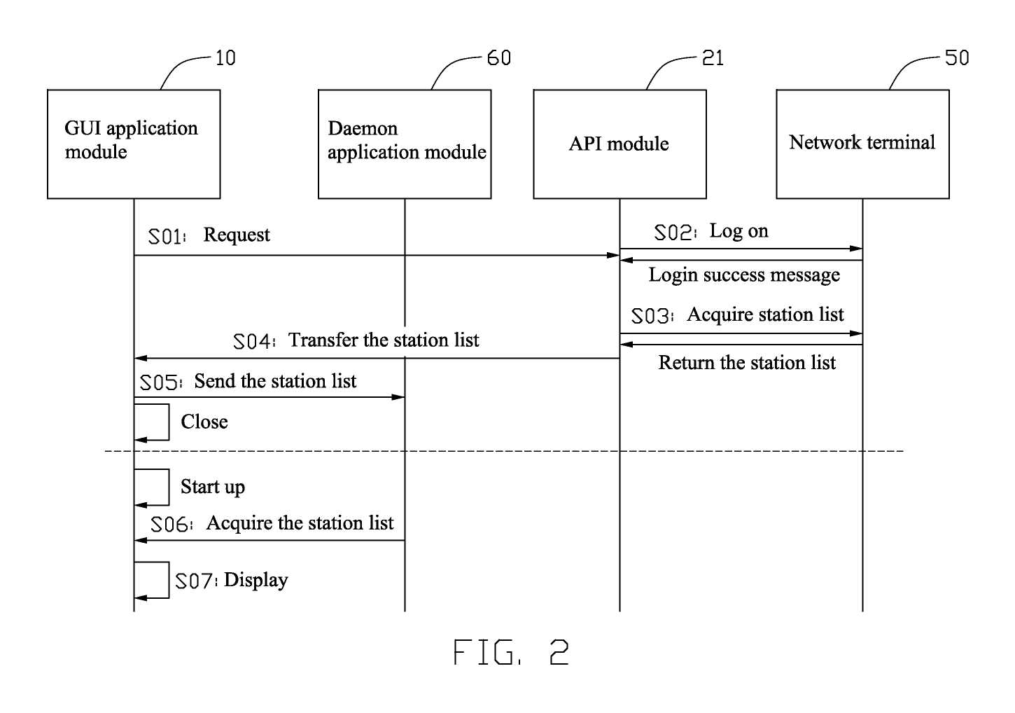

FIG. 2 is a flowchart of a method of an electronic device (e.g. that of FIG. 1) communicating with a network terminal to retrieve network content (e.g. a station list), in accordance with one embodiment.

In block S01, if the electronic device is locked, a username and password are entered to log onto the electronic device. GUI application module 10 sends a request for authorization to the API module 21.

In block S02, the API module 21 logs onto the network terminal 50. The network terminal 50 returns a login success message to the API module 21.

In block S03, the API module 21 acquires the station list from the network terminal 50. The network terminal 50 returns the station list to the API module 21.

In block S04, the API module 21 transfers the station list to the GUI application module 10 for display.

In block S05, the GUI application module 10 sends the station list to the daemon application module 60 for saving. The GUI application module 10 closes. Thus, when the GUI application module 10 is closed, the daemon application module 60 saves the station list.

In block S06, the GUI application module 10 starts up. The GUI application module 10 acquires the station list from the daemon application module 60.

In block S07, the GUI application module 10 displays the station list.

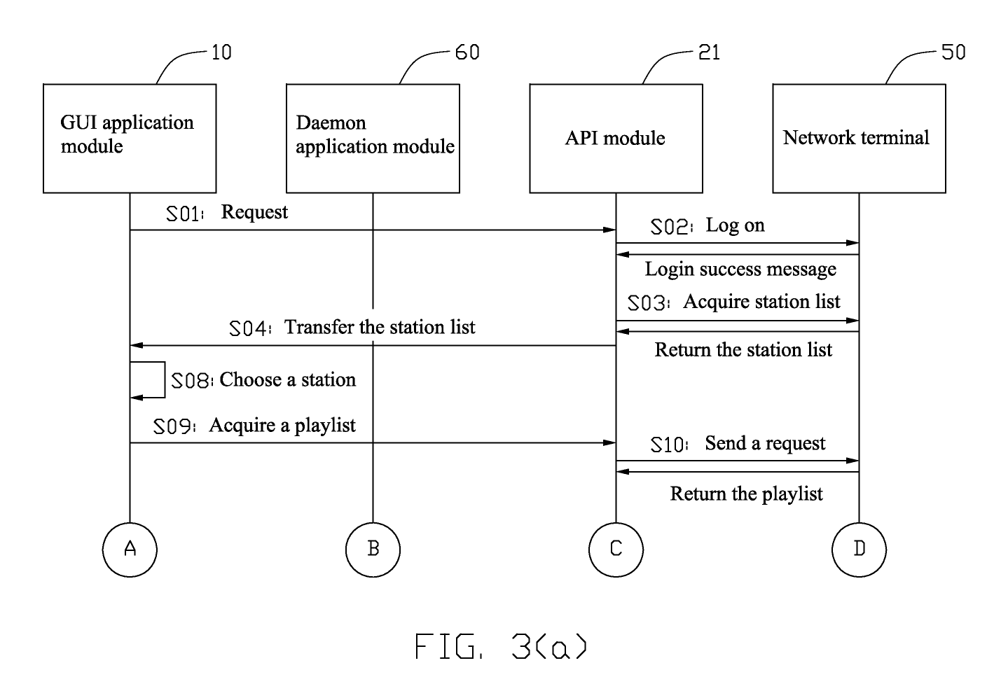

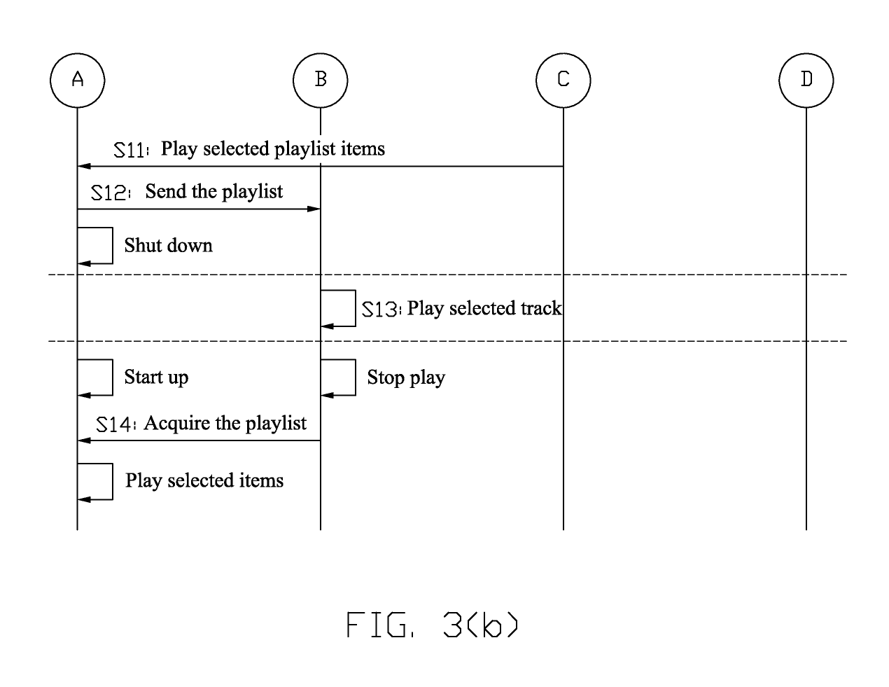

FIG. 3(a) and FIG. 3(b) show flowcharts of a method of an electronic device communicating with a network terminal to retrieve a radio playlist, in accordance with one embodiment.

In block S08, a radio station is chosen from the station list transferred by the API module 21 to the GUI application module 10.

In block S09, the GUI application module 10 acquires a playlist of the station from the API module 21.

In block S10, the API module 21 sends a request to the network terminal 50. The network terminal 50 returns the playlist of the station to the API module 21.

In block S11, the API module 21 plays selected playlist items, for example, the playlist may be played in sequence.

In block S12, the GUI application module 10 sends the playlist to the daemon application module 60. The GUI application module 10 is shut down.

In block S13, the daemon application module 60 includes a playback sub-module. The GUI application module 10 sends a network address to the playback sub-module. The playback sub-module retrieves the network content before the GUI application module 10 exits. At this time, the electronic device is playing a background music file. The daemon application module 60 goes on to play selected tracks from the playlist.

In block S14, the GUI application module 10 starts up. The GUI application module 10 acquires the playlist from the daemon application module 60. The daemon application module 60 stops playback of the playlist items. The GUI application module 10 plays the selected items.

Depending on the embodiment, certain of the steps of methods described may be removed, others may be added, and the sequence of steps may be altered. It is also to be understood that the description and the claims drawn to a method may include some indication in reference to certain steps. However, the indication used is only to be viewed for identification purposes and not as a suggestion as to an order for the steps.

It is to be understood, however, that even though numerous characteristics and advantages have been set forth in the foregoing description of embodiments, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic device comprising:
a display;
a graphical user interface (GUI) application module;
a daemon application module;
a network service control module capable of retrieving network content from a network terminal;
wherein the GUI application module is capable of acquiring the network content from the network service control module, and either of the GUI application module and the daemon application module is capable of managing the network content.

2. The electronic device of claim 1, wherein the GUI application module is capable of sending the network content to the daemon application module for saving before the GUI application module is shut down.

3. The electronic device of claim 2, wherein the GUI application module is capable of retrieving the network content from the daemon application module after the GUI application module is started.

4. The electronic device of claim 1, wherein the network service control module comprises an application program interface module that provides communication between the GUI application module and the network terminal and acquisition of network content.

5. The electronic device of claim 1, wherein the daemon application module comprises a playback sub-module capable of playing the network content after the GUI application module is shut down.

6. The electronic device of claim 5, wherein the GUI application module is capable of sending a network address to the playback sub-module that is capable of retrieving the network content before the GUI application module exits.

7. The electronic device of claim 1, wherein the network content comprises network radio content, and the GUI application module is capable of acquiring the network radio content from the network terminal.

8. The electronic device of claim 7, wherein the network content comprises a personal network radio station list that the GUI application module is capable of acquiring from the network terminal.

9. The electronic device of claim 7, wherein the network content comprises a network radio playlist that the GUI application module is capable of acquiring from the network terminal.

10. The electronic device of claim 9, wherein the daemon application module is capable of selectively playing the playlist items according to a selection via the GUI application module.

11. A method of an electronic device communicating with a network terminal, comprising:
retrieving network content from the network terminal through a network service control module;
acquiring the network content from the network service control module via a GUI application module;
managing the network content by either of the GUI application module or a daemon application module.

12. The method of claim 11, wherein the GUI application module sends the network content to the daemon application module for saving before the GUI application module is shut down.

13. The method of claim 12, wherein the GUI application module retrieves the network content from the daemon application module after the GUI application module is started.

14. The method of claim 11, wherein the network service control module comprises an application program interface module that provides communication between the GUI application module and the network terminal and acquiring network content.

15. The method of claim 11, wherein the daemon application module comprises a playback sub-module capable of playing the network content after the GUI application module is shut down.

16. The method of claim 15, wherein the GUI application module sends a network address to the playback sub-module that is capable of retrieving the network content before the GUI application module exits.

17. The method of claim 11, wherein the network content comprises network radio content, the GUI application module acquires the network radio content from the network terminal.

18. The method of claim 17, wherein the network content comprises a personal network radio station list that the GUI application module acquires from the network terminal.

19. The method of claim 17, wherein the network content comprises a network radio playlist that the GUI application module acquires from the network terminal.

20. The method of claim 19, wherein the daemon application module selectively plays network radio playlist items according to a selection via the GUI application module.
